(19) United States
(12) Patent Application Publication
(10) Pub. No.: US 2021/0199304 A1
(43) Pub. Date: Jul. 1, 2021

(54) METHOD FOR INSTALLING A COOKING SYSTEM

(71) Applicant: BSH Hausgeräte GmbH, Munich (DE)

(72) Inventors: Manuel Almolda Fandos, Zaragoza (ES); Tomas Cabeza Gozalo, Zaragoza (ES); Sergio Llorente Gil, Zaragoza (ES)

(21) Appl. No.: 16/760,489

(22) PCT Filed: Nov. 16, 2018
(86) PCT No.: PCT/IB2018/059038

§ 371 Date: Apr. 30, 2020

(30) Foreign Application Priority Data
Nov. 20, 2017 (ES) P201731338

(51) Int. Cl. F24C 7/06; H05B 6/12; F24C 15/10

(52) U.S. Cl. CPC F24C 7/06; H05B 6/1209; H05B 6/12; F24C 15/10; F24C 7/067

(57) ABSTRACT

In a method for installing a cooking system, an orientation parameter is determined, at least semi-automatically, in the course of an orientation of a position of a heating unit of the cooking system in relation to a desired placement position which is provided for a placement item and defined by a cooktop plate of the cooking system, and the orientation parameter is taken into account during the orientation of the position of the heating unit relative to the desired placement position.

The invention relates to a method for installing a cooking system as claimed in claim 1.

A method for installing a cooking system is already known from the prior art, in which a heating unit of the cooking system is arranged below a cooktop plate of the cooking system. In the course of an orientation of a position of the heating unit relative to the desired placement position, an assembler manually orients the heating unit on the basis of markings on the cooktop plate relative to the desired placement position.

The object of the invention is, in particular, to provide a method for installing a system of the generic type having improved properties with regard to ease of installation. The object is inventively achieved by the features of claim 1, while advantageous embodiments and further developments of the invention can be taken from the subclaims.

A method for installing a cooking system is proposed, which has at least one heating unit and at least one cooktop plate, which defines at least one desired placement position for at least one placement item, in which, in the course of an orientation of a position of the heating unit relative to the desired placement position, in particular on installation and/or assembly and advantageously in situ and/or in the case of an operator at home, at least one orientation parameter is at least semi-automatically determined, in particular electronically and/or while avoiding a manual determination, and taken into consideration during the orientation of the position of the heating unit relative to the desired placement position.

The inventive design makes it possible, in particular, to achieve advantageous properties with regard to ease of installation, and furthermore, in particular, a high level of installation convenience can be achieved. In particular, precise orientation of a position of the heating unit relative to the desired placement position can be made possible, as a result of which optimum cooking results and/or low power losses can be achieved in particular in the case of subsequent cooking processes. In particular, an optimum orientation of a position of the heating unit relative to the desired installation position can be guaranteed. In particular, simple installation can be achieved, and, more precisely, in particular with regard to a relative position of the heating unit to the desired placement position, in particular with regard to a vertical distance of the heating unit from the desired placement position, and/or with regard to a relative angular orientation of the heating unit to the desired placement position. In particular, a maximum efficiency and/or a maximum energy transfer from the heating unit to cookware to be heated and/or optimum coupling between the heating unit and at least one item of cookware placed on it can be made possible.

A “cooking system” should be taken to mean, in particular, a system which has at least one cooking appliance which is provided for cooking food, such as, for example, a baking oven and/or a hob and/or a microwave, and which, in particular, could additionally have at least one further structural unit which is designed to be different from a cooking appliance, such as in particular a cleaning device and/or a refrigeration device and/or a mobile device and/or at least one contact module and/or at least one placement item. In particular, the cooking system is provided to have at least one structural unit which is provided for arrangement in a kitchen. The cooking system could, for example, have at least one accessory unit for the cooking appliance, such as, a sensor unit for external measurement of a temperature of cookware and/or of a product to be cooked and/or a placement item. The cooking system could, in particular, have at least one placement item, in particular the placement item, and/or at least one item of cookware.

In this connection, a “heating unit” should be taken to mean, in particular, a unit which is provided to supply energy for the purpose of heating the cookware and/or the placement item in at least one operating state of at least one item of cookware and/or at least one placement item. For example, the heating unit could be designed as a resistance heating unit and in particular be provided to convert energy into heat and to supply said energy to the cookware and/or to the placement item for the purpose of heating the cookware and/or the placement item. Alternatively or additionally, the heating unit could be designed as an induction heating unit and can be provided, in particular, to supply energy in the form of an electromagnetic alternating field to the cookware and/or to the placement item, wherein the energy supplied to the cookware and/or to the placement item could be converted into heat, in particular in the cookware and/or in the placement item.

In particular, the cooking system has at least one cooktop plate which is provided in particular for positioning at least one item of cookware and/or at least one placement item. A “cooktop plate” should be taken to mean, in particular, at least one, in particular, plate-like unit which is provided for positioning at least one item of cookware and/or for positioning at least one placement item and/or for positioning at least one product to be cooked for the purpose of heating. The cooktop plate could be designed, for example, as a partial region of at least one countertop, in particular at least one kitchen countertop, in particular of the cooking system. Alternatively or additionally, the cooktop plate could be designed as a hob plate. The cooktop plate designed as a hob plate could, in particular, form at least one part of a hob outer housing and, in particular, together with at least one outer housing unit, by means of which the cooktop plate, which is designed as a hob plate, could be connected in particular in at least one installed state, form the outer hob housing at least to a large part. The cooktop plate could, for example, be formed at least to a large part of glass and/or glass ceramic and/or neolite and/or Dekton and/or wood and/or marble and/or stone, in particular natural stone, and/or layered material and/or metal and/or plastic and/or ceramic. “At least to a large part” should be taken to mean, in particular, a proportion, in particular a mass fraction and/or volume fraction, of at least 70%, in particular at least 80%, advantageously at least 90% and preferably at least 95%.

A “desired placement position” should be taken to mean, in particular, a position at which a positioned placement item, in particular at least one item of cookware of a positioned placement item, can be heated, in particular optimally, in particular with maximum energy transfer from the heating unit to the placement item and/or with minimal power losses, and/or below which, in an installation position, the heating unit is arranged and/or which, in at least one operating state, is characterized, in particular marked and/or highlighted, by at least one identification. For example, the cooktop plate could have at least one marking for identifying the desired placement position. The marking could, for example, be at least one imprint of at least one basic body of the cooktop plate and/or at least one coating of at least one basic body of the cooktop plate. The cooking system could alternatively or additionally have, for example, at least one display unit which, in particular in at least one operating state, could identify the desired placement position. The display unit could in particular have at least one light and advantageously at least one illumination means for illuminating the desired placement position.

A desired placement position “for” a placement item should be taken to mean, in particular, that the desired placement position is provided for positioning the placement item, and/or that, in at least one operating state, the placement item is positioned at the desired placement position. A “placement item” should be taken to mean, in particular, an item which is provided for coupling to the heating unit and which, in particular in the course of coupling to the heating unit, receives and/or absorbs energy from the heating unit in at least one operating state. The placement item could, for example, have at least one item of cookware. Alternatively or additionally, the placement item could have at least one support mechanism which could be provided in particular for positioning at least one item of cookware, in particular of the cookware. The placement item has, in particular, at least one coupling unit, which is provided in particular for coupling to the heating unit. The coupling unit has, in particular, at least one coupling element, which is provided in particular for coupling to the heating unit. The coupling element could be designed in particular as a coil. In particular, the placement item could have at least two, advantageously at least three, preferably at least five, and particularly preferably a plurality of coupling elements, which could be provided in particular for coupling to the heating unit.

An “orientation parameter” should be taken to mean, in particular, a parameter which identifies and/or characterizes a position of the heating unit relative to the desired placement position. A “position” of the heating unit relative to the desired placement position should be taken to mean, in particular, a relative position of the heating unit relative to the desired placement position and/or a relative angular orientation of the heating unit relative to the desired placement position. The relative position of the heating unit relative to the desired placement position could be, in particular when viewed perpendicularly to a main extension plane of the cooktop plate, in an installation position, in particular, a horizontal distance between the heating unit and the desired placement position, in particular a degree of overlap of the heating unit with the desired placement position. The horizontal distance between the heating unit and the desired placement position is, in particular when viewed perpendicularly to a main extension plane of the cooktop plate, in particular a shortest connection of a center point and/or center of gravity of the heating unit to a center point and/or center of gravity of the desired placement position. Advantageously, the relative position of the heating unit relative to the desired placement position in an installation position is, in particular, a vertical distance between the heating unit and the desired placement position. The vertical distance between the heating unit and the desired placement position is in particular oriented at least substantially perpendicular to a main extension plane of the cooktop plate. The relative angular orientation of the heating unit relative to the desired placement position could, for example, be a relative orientation of a main extension plane of the heating unit relative to a main extension plane of the cooktop plate and/or a tilting of the heating unit relative to the desired placement position. A “main extension plane” of an object should be taken to mean, in particular, a plane which is parallel to a largest lateral surface of a smallest imaginary geometric cuboid, which just still completely encloses the object, and in particular runs through the center point of the cuboid.

The phrase that, in the course of an orientation of a position of the heating unit relative to the desired placement position, at least one orientation parameter is determined “at least semi-automatically”, should be taken to mean, in particular, that, in the course of an orientation of a position of the heating unit relative to the desired placement position, the orientation parameter is determined semi-automatically and, in particular, it could also be determined fully automatically. The phrase that, in the course of an orientation of a position of the heating unit relative to the desired placement position, at least one orientation parameter is determined at least “semi-automatically” should be taken to mean, in particular, that, in the course of an orientation of a position of the heating unit relative to the desired placement position, the orientation parameter is determined automatically at least in part and, in addition, in particular at least to a further part, could be determined manually. “Automatic” should be taken to mean, in particular, automatically and/or while avoiding manual co-operation.

The cooking system has, in particular, at least one orientation parameter determination unit, which determines the orientation parameter, in particular during the orientation of a position of the heating unit relative to the desired placement position, and takes the orientation parameter into consideration, in particular during the orientation of a position of the heating unit relative to the desired placement position,. The orientation parameter determination unit has, in particular, at least one control unit, which determines the orientation parameter, in particular during the orientation of a position of the heating unit relative to the desired placement position, and takes the orientation parameter into consideration, in particular, during the orientation of a position of the heating unit relative to the desired placement position.

A “control unit” should be taken to mean, in particular, an electronic unit which is preferably provided for controlling and/or regulating at least the heating unit and/or at least part of the cooking appliance. The control unit could, for example, be at least partially integrated in a control and/or regulating unit of at least one cooking appliance, in particular a hob, and in particular be provided for controlling and/or regulating at least one functional unit of the cooking appliance which could be provided in particular for carrying out a main function of the cooking appliance. In particular, the control unit has an arithmetic unit and, in particular, in addition to the arithmetic unit, a storage unit having a control and/or regulating program stored therein, which is provided to be executed by the arithmetic unit.

The orientation parameter determination unit determines, in particular before an orientation of a position of the heating unit relative to the desired placement position and advantageously during the orientation of a position of the placement item relative to the heating unit, at least one placement orientation parameter and takes into consideration the placement orientation parameter, in particular during the orientation of the placement item relative to the heating unit. The positioning device parameter has, in particular, at least one relative position of the placement item relative to the heating unit and/or at least one relative angular orientation of the placement item relative to the heating unit.

The phrase that a parameter is “taken into consideration ” in an orientation should be taken to mean, in particular, that the parameter is used and/or utilized in the orientation and/or that the orientation is carried out and/or implemented as a function of the parameter.

The term “provided” should be taken to mean, in particular, specifically programmed, configured and/or expanded. That an object is provided for a specific function, should be taken to mean, in particular, that the object fulfils and/or executes this particular function in at least one application and/or operating state.

Furthermore, it is proposed that the orientation parameter has at least one relative position of the heating unit relative to the desired placement position. A “relative position” of the first object relative to at least one second object should, in particular in an installation position, be taken to mean at least one vertical distance of the first object from the second object and/or when viewed perpendicularly to a main extension plane of the cooktop plate, at least one horizontal distance of the first object from the second object and/or at least one overlap of the first object with the second object. As a result, optimum cooking results can be achieved, in particular following an orientation of the position of the heating unit relative to the desired placement position.

In addition, it is proposed that the orientation parameter has at least one relative angular orientation of the heating unit relative to the desired placement position. A “relative angular orientation” of a first object relative to at least one second object should be taken to mean, in particular, a relative orientation of a main extension plane of the first object relative to a main extension plane of the second object and/or a tilting of the first object relative to the second object. As a result, in particular heating of at least one positioned placement item distributed uniformly over a surface extension of the desired placement position can be made possible, as a result of which, in particular, a high degree of operating convenience can be achieved.

The orientation parameter could, for example, be determined automatically, in particular fully automatically, during the orientation of a position of the heating unit relative to the desired placement position, in particular internally in the orientation parameter determination unit, and automatically, in particular fully automatically, such as, for example, during the orientation of a position of the heating unit relative to the desired placement position performed mechanically, for example by at least one control unit. In this case, it is possible, in particular, to dispense with an output of the orientation parameter via at least one output unit of the cooking system. During the orientation of a position of the heating unit relative to the desired placement position, the orientation parameter is preferably output via at least one output unit, in particular optically and/or acoustically and/or haptically. The output of the orientation parameter could in particular be carried out fully automatically and/or at least semi-automatically. In particular, the cooking system has at least one output unit, in particular the output unit. An “output unit” should be taken to mean, in particular, a unit which is provided to supply at least one characteristic variable to an operator, in particular optically and/or acoustically and/or haptically, such as, for example, information and/or a time indication and/or an operating request and/or an action request and/or a selection. The output unit could in particular be provided to output at least one acoustic signal and/or in particular at least one acoustic sequence, such as, for example, a ringing tone and/or a warning signal and/or a request in the form of an in particular prefabricated set. Alternatively or additionally, the output unit could be provided to supply an optical output, such as, a display of at least one image and/or at least one text and/or at least one digit and/or at least one animation. For example, the output unit could have at least one loudspeaker. Alternatively or additionally, the output unit could have a display unit, in particular with at least one lighting means, advantageously an LED, and/or an in particular backlit display, in particular a matrix display and/or an LCD display, an OLED display and/or electronic paper. The output unit advantageously has at least one liquid crystal display. The orientation parameter determination unit is provided, in particular, for communication and/or interaction with the operator, in particular via the output unit and/or via at least one operator interface. The orientation parameter determination unit is provided, in particular, to control the output unit in at least one operating state and to output the orientation parameter to an operator and/or to an assembler, in particular by means of the output unit. In particular, the cooking system has at least one operator interface which, in particular, could be at least partially part of the cooking appliance. In this way, in particular a convenient orientation of the heating unit relative to the desired placement position can be made possible.

The output unit could, for example, be at least partially part of the cooking appliance, in particular at least one operator interface. In particular, the output unit could have at least one display, in particular a liquid crystal display. Alternatively or additionally, the output unit could be at least partially part of an external screen, such as, a computer screen and/or a television screen. The external screen could in particular be connected to the cooking appliance and/or to the placement item and/or in particular communicate wirelessly with the cooking appliance and/or with the placement item. The output unit is preferably at least partially part of a mobile device. The orientation parameter could be output in particular by means of at least one application. The phrase that a first object is “at least partially” part of a second object should be taken to mean, in particular, that the first object has at least one sub-region, in particular at least one element and/or at least one unit, which is part of the second object and, in particular, in addition to the sub-region, could have at least one further sub-region which could in particular be part of at least one third object different from the second object. The mobile device could be, for example, a cell phone and/or a mobile telephone and/or a laptop and/or a tablet. In this way, it is possible, in particular, to achieve convenient installation, since in particular the output unit can be positioned continuously within range and/or in the visible range independently of a location of the installation. This is particularly advantageous, for example, in the case of installing which takes place in an installation position below the cooktop plate, since in this case, in particular, a continuous changing of a working position of a fitter, in order in particular to be able to look at an output unit located above the cooktop plate, can be avoided.

For example, during the orientation of a position of the heating unit relative to the desired placement position, a position of the heating unit could be kept constant and a position of the desired placement position could be changed. Preferably, during the orientation of a position of the heating unit relative to the desired placement position, a position of the heating unit is changed and a position of the desired placement position is kept constant. In particular, during the orientation of a position of the heating unit relative to the desired placement position, the heating unit is moved and the desired placement position is retained. The cooking system has, in particular, at least one movement unit which is provided, in particular, to move the heating unit and/or at least one heating unit carrier unit, and, more precisely, in particular relative to the desired installation position and/or relative to at least one carrier unit, the position of which is kept in particular constant. In particular, the cooking system has at least one heating unit carrier unit which, in an installation position, absorbs in particular a weight force of the heating unit and transfers it, in particular, to at least one further unit, in particular to at least one carrier unit and/or to at least one piece of furniture and/or to at least one housing unit of the cooking system. In particular, the cooking system has at least one carrier unit which, in an installation position, in particular absorbs a weight force of the heating unit and/or of the heating unit carrier unit and transfers it, in particular, to at least one further unit, in particular to at least one piece of furniture and/or to at least one housing unit of the cooking system. In an installation position, the movement unit connects in particular the heating unit and/or the heating unit carrier unit to the carrier unit. For example, the movement unit could have at least one hexapod and/or by means of at least one smartpot, which could be provided, in particular, to move the heating unit and/or the heating unit carrier unit. Alternatively or additionally, the movement unit could have at least one movement element which, in particular, could be provided to move the heating unit and/or the heating unit carrier unit. The movement element could, in particular, be connected to the heating unit and/or to the heating unit carrier unit by means of at least one thread and can move said unit in particular by means of the thread. The thread could, for example, have a metric in a range of three to eight. As a result, in particular simple and/or rapid and/or uncomplicated installation can be made possible, since in particular the heating unit can be moved more easily than the desired placement position, during the movement of which in particular the entire cooktop plate would have to be moved.

Furthermore, it is proposed that, when the orientation parameter is determined, the heating unit and the placement item are in particular electrically coupled to one another. In particular, the orientation parameter determination unit has at least one sensor unit which detects at least one coupling parameter when a position of the heating unit is oriented relative to the desired placement position. A “sensor unit” should be taken to mean, in particular, a unit which has at least one sensor and/or detector for detecting the coupling parameter and/or the orientation parameter and/or the placement orientation parameter and which is provided to output a value characterizing the coupling parameter and/or the orientation parameter and/or the placement orientation parameter, wherein the coupling parameter and/or the orientation parameter and/or the placement orientation parameter are advantageously a physical and/or chemical variable. The term “detect” should be taken to mean, in particular, measuring and/or determining. A “coupling parameter should be taken to mean, in particular, a parameter, in particular an electrical and/or electronic and/or magnetic and/or electromagnetic parameter, which records and/or characterizes a coupling of the heating unit and the placement item. For example, the heating unit could be at least partially part of the orientation parameter determination unit, in particular the sensor unit of the orientation parameter determination unit. In particular, the placement item, in particular the coupling unit of the placement item, could be part of the sensor unit and could be at least partially part of the orientation parameter determination unit, in particular the sensor unit of the orientation parameter determination unit. The coupling parameter could, for example, be at least one inductance and/or at least one induced voltage and/or an impedance and/or a ratio of a real part and an imaginary part of an impedance and/or a magnetic flux and/or an electromagnetic alternating field. In the event of an orientation of a position of the heating unit relative to the desired placement position, the orientation parameter determination unit compares in particular a current coupling parameter detected in particular by the sensor unit with at least one reference value for the coupling parameter. In particular, the orientation parameter determination unit could have at least one storage unit in which, in particular, at least one reference value for the coupling parameter could be stored. Advantageously, a large number of reference values, which could be stored in particular in tabular form and/or in the form of at least one mathematical function, is stored in the storage unit of the orientation parameter determination unit. During the orientation of a position of the heating unit relative to the desired placement position, the orientation parameter determination unit brings in particular a current coupling parameter, in particular detected by the sensor unit, into alignment with the reference value for the coupling parameter and, in particular, orients the heating unit relative to the desired placement position. In order to couple the heating unit and the placement item to one another, the orientation parameter determination unit in particular controls the heating unit and provides an electromagnetic alternating field by means of the heating unit. In particular, the coupling unit of the placement item detects the electromagnetic alternating field provided by the heating unit, and, more precisely, by changing at least the coupling parameter. The orientation parameter determination unit determines the orientation parameter, in particular on the basis of the coupling parameter, in particular on the basis of a change in the coupling parameter. For example, the orientation parameter determination unit could determine the orientation parameter that has at least one relative position of the heating unit relative to the desired placement position which, in particular in an installation position, has at least one vertical distance of the heating unit from the desired installation position, by means of a coupling parameter, which in particular could be an inductance and/or a ratio of a real part and an imaginary part of an impedance. Alternatively or additionally, the orientation parameter determination unit could determine the orientation parameter, which has at least one relative angular orientation of the heating unit relative to the desired placement position, by means of a coupling parameter which could be an induced voltage in particular. As a result, the orientation parameter can be determined in particular in a technically simple and/or reliable manner.

Furthermore, it is proposed that the orientation is checked following the orientation of the position of the heating unit relative to the desired placement position. In order to check the position of the heating unit relative to the desired placement position, the orientation parameter determination unit provides, in particular by means of the heating unit, at least one electromagnetic alternating field, in particular for heating at least one placement item positioned at the desired placement position. In particular, the orientation parameter determination unit, in particular the sensor unit of the orientation parameter determination unit, detects a course of an energy supplied to the placement item, in particular as a function of a frequency. When checking the position of the heating unit relative to the desired installation position, the orientation parameter determination unit compares in particular the course of an energy supplied to the installation unit with at least one reference value for the course of an energy supplied to the placement item. The reference value for the course of an energy supplied to the placement item could be stored, in particular, in the storage unit of the orientation parameter determination unit, and, more precisely, in tabular form and/or in the form of at least one mathematical function. As a result, a high level of operating convenience can be achieved, in particular, since, in particular in the case of a faulty orientation of the heating unit relative to the desired placement position, which is determined on checking, a correction of the orientation of the heating unit relative to the desired placement position can be made.

When checking the position of the heating unit relative to the desired placement position, the same placement item could be positioned, for example, as in the orientation of the position of the heating unit relative to the desired placement position. Preferably, a further placement item different from the placement item is used for checking the orientation. The further placement item could, for example, be constructed at least partially and advantageously completely identically to the placement item and in particular have at least one item of cookware and/or at least one support mechanism. Alternatively, the placement item and the further placement item could be designed differently from one another. The further placement item could, for example, have at least one item of cookware and be designed in particular as the cookware. As a result, it is possible, in particular, to avoid any incorrect orientation of the heating unit relative to the desired installation position, which could result in particular from a faulty installation unit.

A particularly high level of operating convenience can be achieved, in particular, by a cooking system which is installed according to a method for installing a cooking system. In an installation position and in particular in an oriented state of a position of the heating unit relative to the desired installation position, the heating unit has, in particular, a vertical distance from the desired installation position of at least 10 mm, in particular of at least 15 mm, advantageously of at least 20 mm, particularly advantageously of at least 25 mm and preferably of at least 30 mm. In particular, the heating unit has a vertical distance from the desired placement position of a maximum of 60 mm, in particular of a maximum of 55 mm, advantageously of a maximum of 50 mm, particularly advantageously of a maximum of 45 mm and preferably of a maximum of 40 mm, in an installation position and in particular in an oriented state of a position of the heating unit relative to the desired placement position.

Furthermore, it is proposed that the cooking system has at least one orientation parameter determination unit, which is provided for determining the orientation parameter. In particular, the orientation parameter determination unit determines the orientation parameter during the orientation of a position of the heating unit relative to the desired placement position. This makes it possible, in particular, to provide a high level of operating convenience and/or optimum cooking results.

In addition, it is proposed that the orientation parameter determination unit has the heating unit. The heating unit is in particular at least partially part of the orientation parameter determination unit, in particular the sensor unit of the orientation parameter determination unit. As a result, in particular a compact design and/or a large variety of components can be made possible.

Furthermore, it is proposed that the cooking system has at least one placement item which is at least partially part of the orientation parameter determination unit, in particular the sensor unit of the orientation parameter determination unit, as a result of which the orientation parameter can be determined in particular especially reliably, since in particular properties of the placement item are known and can thus be taken into consideration in particular by the orientation parameter determination unit.

Furthermore, it is proposed that the placement item has at least one item of cookware. As a result, the placement item can be used in particular flexibly, and, more precisely, in particular during the orientation of a position of the heating unit relative to the desired placement position and also in the case of at least one cooking process.

The placement item could, for example, have, in addition to the cookware, exclusively the coupling unit and, in particular, be free of a support mechanism. Preferably, the placement item has at least one support mechanism which is provided for positioning at least one item of cookware, in particular the cookware of the placement item. A “support mechanism” should be taken to mean, in particular, a device which is intended, in particular, for positioning, in particular for placement, on the cooktop plate and for positioning at least one item of cookware and which, in particular in at least one heating operating state, at least partially forms a support for the cookware. In an installation position, the support device is provided, in particular, for placement above the heating unit. In particular, the support mechanism is provided for absorbing at least one heat energy coming from a positioned item of cookware and/or preventing it from reaching the cooktop plate. As a result, the cooktop plate can be protected, in particular in at least one heating operating state, from damage, which could be caused, in particular, by overheating due to the energy transferred from the cookware to the cooktop plate, as a result of which, in particular, a durable design can be achieved.

The method for installing a cooking system and/or the cooking system should not be limited to the application and embodiment described above. In particular, the method, for installation of a cooking system and/or the cooking system for fulfilling a mode of operation described herein, can have a number of individual elements, components and units which differs from a number disclosed herein.

Further advantages result from the following description of the drawings. Exemplary embodiments of the invention are shown in the drawings. The drawings, the description and the claims contain numerous features in combination. The person skilled in the art will expediently also consider the features individually and combine them into meaningful further combinations.

### IN THE DRAWINGS

FIG. 1 shows a detail of a cooking system with a cooktop plate, a control unit, an operator interface and a heating unit in a schematic plan view,

FIG. 2 shows a detail of the cooking system in a schematic partial sectional view,

FIG. 3 shows an enlarged detail from FIG. 2, in which a detail of a carrier unit, a heating unit and a movement unit of the cooking system is illustrated,

FIG. 4 shows an alternative embodiment to the embodiment illustrated in FIG. 3 in a schematic partial sectional view,

FIG. 5 shows a placement item of the cooking system of FIG. 1 in a schematic plan view, wherein an illustration of electrical connections between coupling elements of a coupling unit of the placement item has been dispensed with,

FIG. 6 shows a placement item of an alternative cooking system in a schematic plan view, wherein an illustration of electrical connections between coupling elements of a coupling unit of the placement item has been dispensed with,

FIG. 7 shows a placement item of an alternative cooking system in a schematic plan view, wherein an illustration of electrical connections between coupling elements of a coupling unit of the placement item has been dispensed with,

FIG. 8 shows the cooking system of FIG. 1 in an orientation of a position of a heating unit of the cooking system relative to a desired placement position of a cooktop plate of the cooking system in a method step in a schematic plan view,

FIG. 9 shows the cooking system from FIG. 1 in an orientation of a position of the heating unit relative to the desired installation position in a further method step in a schematic plan view,

FIG. 10 shows the cooking system from FIG. 1 in an orientation of a position of the heating unit relative to the desired installation position in a further method step in a schematic plan view,

FIG. 11 shows a mobile device and an output unit of the cooking system, which output unit is part of the mobile device, in a method step in a schematic representation,

FIG. 12 shows the mobile device and the output unit in a further method step in a schematic representation,

FIG. 13 shows the mobile device and the output unit in a further method step in a schematic representation,

FIG. 14 shows the mobile device and the output unit in a further method step in a schematic representation,

FIG. 15 shows the mobile device and the output unit in a further method step in a schematic representation,

FIG. 16 shows the mobile device and the output unit in a further method step in a schematic representation,

FIG. 17 shows a section of the cooking system from FIG. 1 in a schematic partial sectional view,

FIG. 18 shows the mobile device and the output unit in a further method step in a schematic representation,

FIG. 19 shows a graph illustrating a plurality of courses of a coupling parameter for the case of a horizontal distance between a heating unit and a desired placement position, in a schematic representation, wherein each of the courses represents a horizontal distance of the heating unit from the placement item,

FIG. 20 shows a graph illustrating a plurality of courses of a coupling parameter for the case of a vertical distance between the heating unit and the desired placement position, in a schematic illustration, wherein each of the courses represents a vertical distance of the heating unit from the desired placement position,

FIG. 21 shows an alternative cooking system in a state before carrying out a method for installing the cooking system in a schematic partial sectional view,

FIG. 22 shows an output unit of the cooking system of FIG. 21, which is part of a mobile device of the cooking system, in a method step in a schematic representation,

FIG. 23 shows the output unit in a further method step in a schematic representation,

FIG. 24 shows the output unit in a further method step in a schematic representation,

FIG. 25 shows the output unit in a further method step in a schematic representation,

FIG. 26 shows the output unit in a further method step in a schematic representation,

FIG. 27 shows the output unit in a further method step in a schematic representation,

FIG. 28 shows the output unit in a further method step in a schematic representation,

FIG. 29 shows the output unit in a further method step in a schematic representation and

FIG. 30 shows the cooking system in a state following implementation of the method for assembling the cooking system in a schematic partial sectional view.

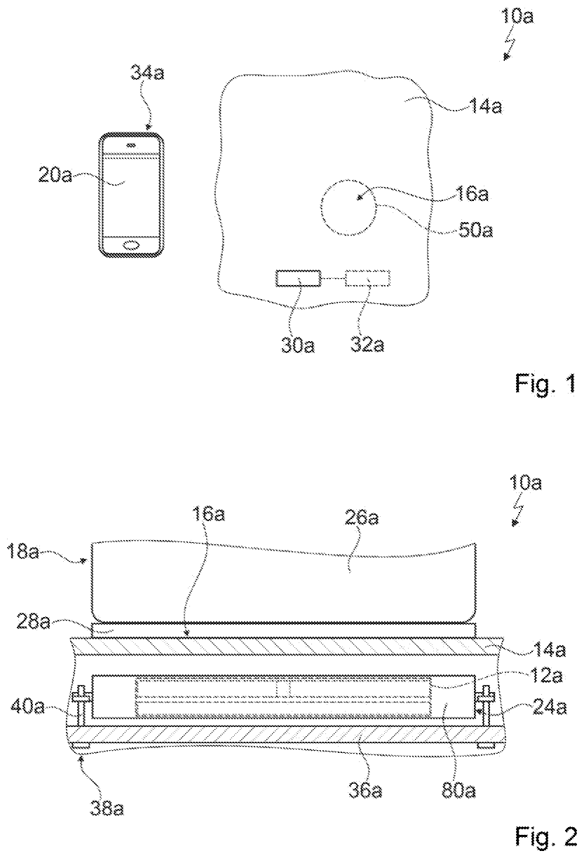

FIG. 1 shows a cooking system 10a which is designed as an induction cooking system and which is installed according to a method for installing the cooking system 10a. The cooking system 10a has a cooktop plate 14a. The cooktop plate 14a defines a desired placement position 16a for a placement item 18a (cf. also FIG. 2). In an assembled state, the cooktop plate 14a forms a visible surface which, in an installed state, is arranged, in particular, facing an operator. The cooktop plate 14a is provided for positioning the placement item 18a, in particular an item of cookware 26a and/or a support mechanism 28a of the placement item 18a, in particular at the desired placement position 16a for heating (cf. FIGS. 1 and 2). In the present exemplary embodiment, the cooktop plate 14a is designed as a working plate, in particular as a kitchen worktop.

The cooking system 10a has an operator interface 30a for inputting and/or selecting operating parameters, for example a heating power and/or a heating power density and/or a heating zone. The operator interface 30a is provided for outputting a value of an operating parameter to an operator.

The cooking system 10a has a control unit 32a. The control unit 32a is provided to carry out actions and/or to change settings as a function of operating parameters input by means of the operator interface 30a. In a heating operating state, the control unit 32a regulates an energy supply to at least one heating unit 12a.

The cooking system 10a has a plurality of heating units 12a (cf. FIGS. 1 and 2), of which only one is illustrated in the figures and of which only one is described below. The heating unit 12a is provided for heating cookware 26a placed on the cooktop plate 14a above the heating unit 12a and, in particular, at the desired placement position 16a. The heating unit 12a is designed as an induction heating unit. The heating unit 12a is arranged below the cooktop plate 14a in an installation position, and, more precisely, below the desired placement position 16a.

The cooking system 10a has one heating unit carrier unit 80a per heating unit 12a (cf. FIG. 2). The heating unit carrier unit 80a carries the heating unit 12a in an installation position. The heating unit carrier unit 80a could, for example, have a coil carrier and/or a screening element and/or a housing unit.

The cooking system 10a has a carrier unit 36a (cf. FIG. 2). In an installation position, the carrier unit 36a is arranged below the cooktop plate 14a. In an installation position, the heating unit 12a is supported on the carrier unit 36a. In an installation position, the carrier unit 36a absorbs a weight force of the heating unit 12a and/or of the heating unit carrier unit 80a. In an installation position, the carrier unit 36a transfers a weight force of the heating unit 12a and/or of the heating unit carrier unit 80a to at least one further unit, such as, for example, a housing unit and/or a piece of furniture.

The cooking system 10a has a movement unit 38a (cf. FIG. 2). The movement unit 38a is provided for moving the heating unit 12a and/or the heating unit carrier unit 80a. In an installation position, the movement unit 38a supports the heating unit 12a, in particular the heating unit carrier unit 80a, on the carrier unit 36a. In an installation position, the heating unit 38a connects the heating unit 12a, in particular the heating unit carrier unit 80a, and the carrier unit 36a to one another.

The movement unit 38a has at least one movement element 40a. In the present exemplary embodiment, the movement unit 38a has, in particular per heating unit 12a, four movement elements 40a, of which only two are shown in FIG. 2. In the figures, only one of multiple objects is provided with a reference numeral.

In each case one movement element 40a is arranged in a corner region of the heating unit 12a, in particular in a corner region of the heating unit carrier unit 80a, when viewed perpendicularly to a main extension plane of the heating unit 12a. The movement unit 38a is provided, in particular by means of the movement elements 40a, in order to change a relative position of the heating unit 12a, in particular the heating unit carrier unit 80a, relative to the desired installation position 16a. The movement unit 38a is provided, in particular by means of the movement elements 40a, in order to change a relative angular orientation of the heating unit 12a, in particular the heating unit carrier unit 80a, relative to the desired installation position 16a. Only one of the movement elements 40a is described below.

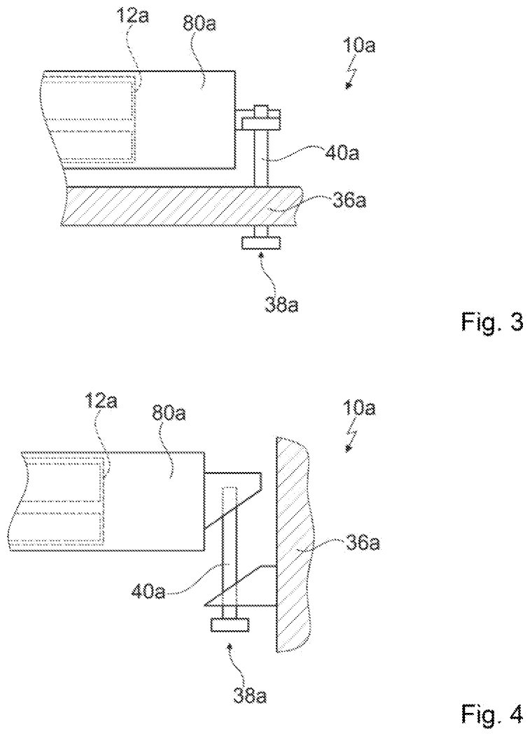

In the present exemplary embodiment, the carrier unit 36a is arranged below the heating unit 12a and/or below the cooktop plate 14a in an installation position. A main extension plane of the carrier unit 36a and a main extension plane of the cooktop plate 14a are oriented substantially parallel to one another. The movement unit 38a, in particular the movement element 40a of the movement unit 38a, extends partially through the carrier unit 36a (cf. FIGS. 2 and 3). The movement unit 38a, in particular the movement element 40a of the movement unit 38a, extends partially through a partial region of the heating unit 12a, in particular through a partial region of the heating unit carrier unit 80a.

The movement unit 38a, in particular the movement element 40a of the movement unit 38a, and the carrier unit 36a are connected to one another via a thread. By means of the thread, a relative position of the heating unit 12a relative to the desired placement position 16a and/or a relative angular orientation of the heating unit 12a relative to the desired placement position 16a can be changed, in particular by means of the movement unit 38a.

In an alternative exemplary embodiment, the carrier unit 36a could be arranged, in an installation position, partially to the side of the heating unit 12a, in particular the heating unit carrier unit 80a (cf. FIG. 4). A main extension plane of the carrier unit 36a and a main extension plane of the support plate 14a could be oriented substantially perpendicular to each other.

For example, the carrier unit 36a could be formed partially in one piece with a housing wall and/or with a furniture wall. The carrier unit 36a could, for example, be part of a housing wall and/or a furniture wall.

In a method for assembling the cooking system 10a, the heating unit 12a is oriented relative to the desired placement position 16a. A placement item 18a is positioned on the cooktop plate 14a, in particular in a close range of the desired placement position 16a. The placement item 18a is specifically provided for the method for installing the cooking system 10a. The cooking system 10a has the placement item 18a (cf. FIGS. 2 and 5 to 7).

The placement item 18a has an item of cookware 26a. In the present exemplary embodiment, the placement item 18a has a support mechanism 28a. The support mechanism 28a is provided for positioning the cookware 26a.

In the method for installing the cooking system 10a, an orientation parameter is determined semi-automatically in the course of an orientation of a position of the heating unit 12a relative to the desired placement position 16a, and, more precisely, by means of an orientation parameter determination unit 24a. The cooking system 10a has the orientation parameter determination unit 24a (cf. FIGS. 2 and 5 to 7). The orientation parameter determination unit 24a is provided for determining the orientation parameter.

When the orientation parameter is determined, the heating unit 12a and the receiving unit 18a are coupled to one another. When the orientation parameter is determined, the orientation parameter determination unit 24a detects a coupling parameter between the heating unit 12a and the placement item 18a. The coupling parameter characterizes a coupling of the heating unit 12a and the placement item 18a. The coupling parameter is an electrical parameter.

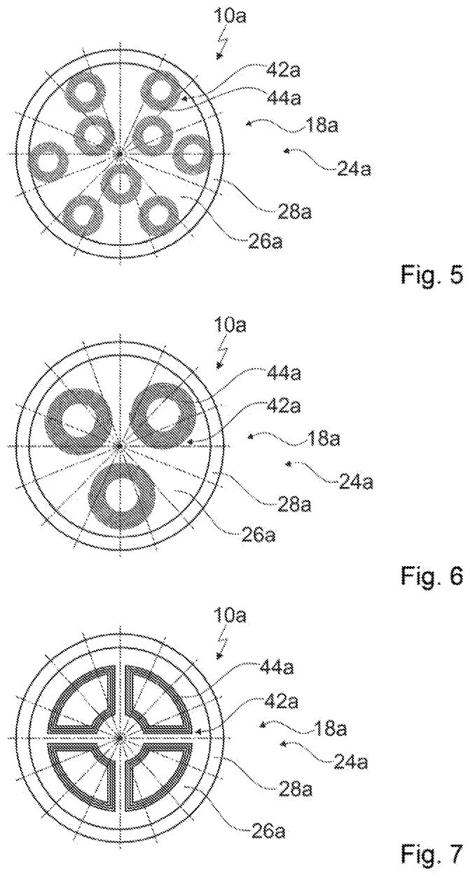

The placement item 18a has a coupling unit 42a (cf. FIG. 5 to 7). The coupling unit 42a is provided for coupling to the heating unit 12a. During the orientation of a position of the heating unit 12a relative to the desired placement position 16a, the coupling unit 42a couples to the heating unit 12a. In the present exemplary embodiment, the coupling unit 42a has nine coupling elements 44a. When viewed perpendicularly to a main extension plane of the cooktop plate 14a, the coupling elements 44a are arranged substantially uniformly over a surface extension of the placement item 18a.

FIG. 6 shows an alternative embodiment of the coupling unit 42a. The coupling unit 42a has three coupling elements 44a. The coupling elements 44a are distributed substantially uniformly over a surface extension of the placement item 18a when viewed perpendicularly to a main extension plane of the cooktop plate 14a. When viewed perpendicularly to a main extension plane of one of the coupling elements 44a, the coupling elements 44a have a circular shape.

FIG. 7 shows an alternative embodiment of the coupling unit 42a. The coupling unit 42a has four coupling elements 44a. The coupling elements 44a are distributed substantially uniformly over a surface extension of the placement item 18a when viewed perpendicularly to a main extension plane of the cooktop plate 14a. When viewed perpendicularly to a main extension plane of one of the coupling elements 44a, the coupling elements 44a have a circle segment shape, in which in particular a tip of the circle segment is cut off.

Only one of the coupling elements 44a is described below on the basis of the coupling unit 42a shown in FIG. 5. The coupling element 44a is partially part of the support mechanism 28a. Alternatively or additionally, the coupling element 44a could be part of the cookware 26a. The coupling element 44a is formed as a coil. When viewed perpendicularly to a main extension plane of the coupling element 44a, the coupling element 44a has a circular shape.

To determine the orientation parameter, the orientation parameter determination unit 24a has the heating unit 12a. The heating unit 12a is partially part of the orientation parameter determination unit 24a. The orientation parameter determination unit 24a has the placement item 18a, and, more precisely, the coupling unit 42a of the placement item 18a.

The placement item 18a is partially, and, more precisely, in particular in the form of the coupling unit 42a of the placement item 18a, part of the orientation parameter determination unit 24a.

In the method for assembling the cooking system 10a, the orientation parameter is taken into consideration during the orientation of a position of the heating unit 12a relative to the desired placement position 16a. The orientation parameter is output by an output unit 20a during the orientation of a position of the heating unit 12a relative to the desired placement position 16a. The cooking system 10a has the output unit 20a.

In the present exemplary embodiment, the cooking system 10a has a mobile device 22a. The output unit 20a is partially part of the mobile device 22a. For example, the output unit 20a could, in particular, additionally be part of the operator interface 30a.

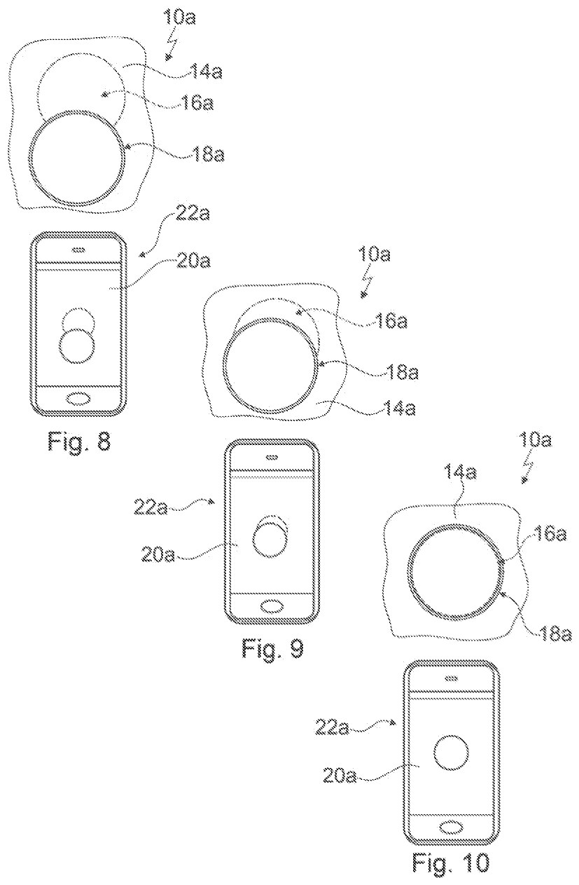

During the orientation of a position of the heating unit 12a relative to the desired placement position 16a, a relative position of the heating unit 12a relative to the placement item 18a is determined, and, more precisely, by the orientation parameter determination unit 24a. The placement parameter has a relative position of the heating unit 12a relative to the desired position 16a (cf. FIG. 8 to 12).

In addition to the orientation parameter, in the method for installing the cooking system 10a, in the course of an orientation of a position of the heating unit 12a relative to the desired placement position 16a, a placement orientation parameter is determined semi-automatically, and, more precisely, by the orientation parameter determination unit 24a. The orientation parameter determination unit 24a is provided for determining the placement orientation parameter.

During the orientation of a position of the heating unit 12a relative to the desired placement position 16a, a relative position of the placement item 18a relative to the heating unit 12a is determined, and, more precisely, by the orientation parameter determination unit 24a. The placement orientation parameter has a relative position of the placement item 18a relative to the heating unit 12a (cf. FIG. 8 to 10).

The relative position of the placement item 18a relative to the heating unit 12a has a horizontal distance of the placement item 18a relative to the heating unit 12a when viewed perpendicularly to a main extension plane of the cooktop plate 14a. The horizontal distance of the placement item 18a relative to the heating unit 12a corresponds to an overlap of the placement item 18a with the heating unit 12a when viewed perpendicularly to a main extension plane of the cooktop plate 14a.

When the placement unit 18a is oriented relative to the heating unit 12a, the orientation parameter determination unit 24a outputs the position of the heating unit 12a and/or the desired placement position 16a and a current position of the placement item 18a, in particular relative to the desired placement position 16a, via the output unit 20a. Depending on the placement orientation parameter, a position of the placement item 18a is changed and a position of the desired placement position 16a and/or a position of the heating unit 12a is kept constant. The position of the placement item 18a is changed until the position of the placement item 18a and the position of the desired placement position 16a and/or the position of the heating unit 12a are arranged so as to overlap when viewed perpendicularly to a main extension plane of the cooktop plate 14a (cf. FIG. 8 to 10).

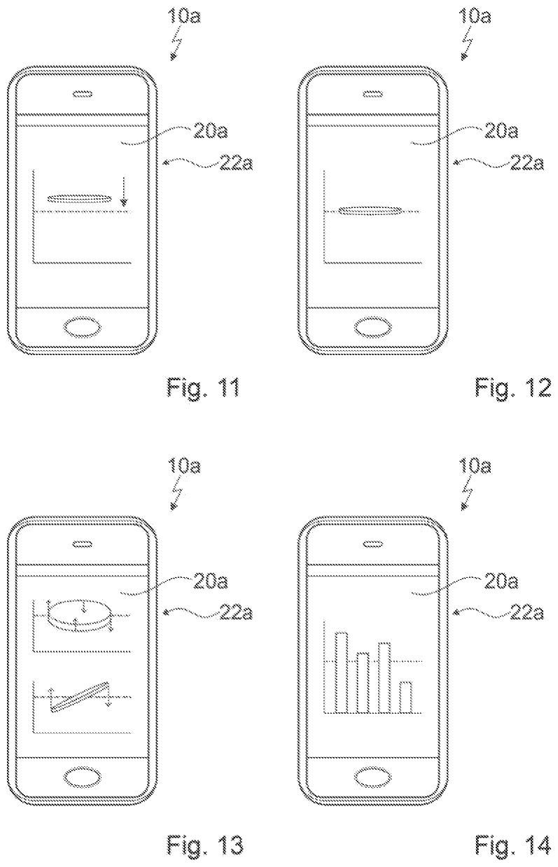

During the orientation of a position of the heating unit 12a relative to the desired placement position 16a, a relative position of the heating unit 12a relative to the desired placement position 16a is determined, and, more precisely, in particular by the orientation parameter determination unit 24a. The orientation parameter has a relative position of the heating unit 12a relative to the desired position 16a (cf. FIGS. 11 and 12).

In an installation position, the relative position of the heating unit 12a relative to the desired placement position 16a has a vertical distance from the heating unit 12a to the desired placement position 16a (cf. FIGS. 11 and 12). The vertical distance of the heating unit 12a from the desired placement position 16a is substantially perpendicular to a main extension plane of the cooktop plate 14a.

During the orientation of a position of the heating unit 12a relative to the desired positioning position 16a, the orientation parameter determination unit 24a outputs a desired position for the heating unit 12a and a current position of the heating unit 12a, in particular relative to the desired position for the heating unit 12a, via the output unit 20a (cf. FIG. 11). During the orientation of a position of the heating unit 12a relative to the desired placement position 16a, the orientation parameter determination unit 24a outputs a direction of movement, in which the heating unit 12a is to be moved in order, in particular, to move the heating unit 12a from the current position of the heating unit 12a into the desired position for the heating unit 12a and, in particular, to allow the heating unit 12a to be arranged in the desired position for the heating unit 12a. Depending on the orientation parameter, a position of the heating unit 12a is changed and a position of the desired placement position 16a is kept constant. The position of the heating unit 12a is changed in particular by means of the movement unit 38a until the position of the heating unit 12a and the desired position for the heating unit 12a are arranged so as to overlap (cf. FIGS. 11 and 12).

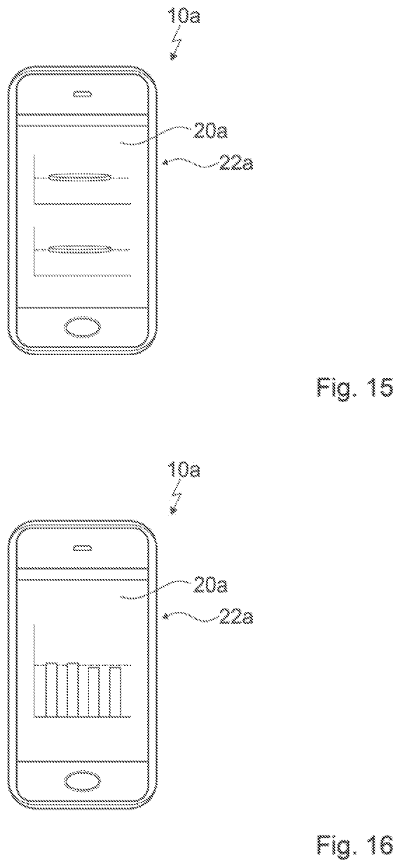

The orientation parameter has a relative angular orientation of the heating unit 12a relative to the desired placement position 16a (cf. FIG. 13 to 16). During the orientation of a position of the heating unit 12a relative to the desired placement position 16a, the orientation parameter determination unit 24a outputs relative angular orientation of the heating unit 12a relative to the desired positioning position 16a and/or relative to the desired position for the heating unit 12a via the output unit 20a, and, more precisely, in particular in at least two different views (cf. FIG. 12). When a position of the heating unit 12a is oriented relative to the desired placement position 16a, the orientation parameter determination unit 24a outputs a position of the movement element 40a, in particular of each movement element 40a, relative to a desired position of the movement element 40a, in particular relative to a desired position of each movement element 40a (cf. FIG. 14). The position of the heating unit 12a is changed in particular by means of the movement unit 38a until the position of the heating unit 12a and the desired position for the heating unit 12a are arranged in an overlapping manner (cf. FIG. 13 to 16).

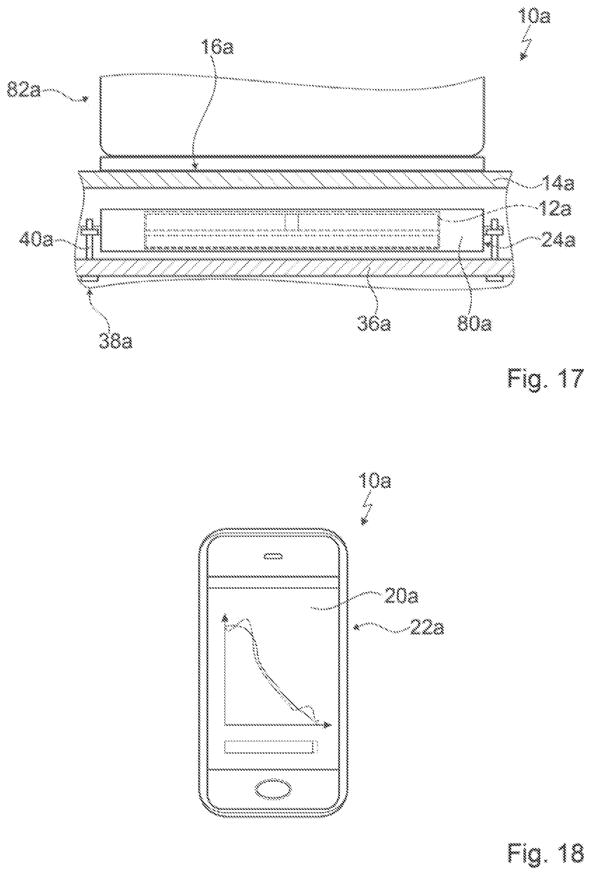

Following the orientation of the position of the heating unit 12a relative to the desired placement position 16a, the orientation is checked. When checking the orientation, a further placement item 82a is positioned at the desired placement position 16a (cf. FIG. 17). In the present exemplary embodiment, a further placement item 82a different from the placement item 18a is used when checking the orientation. When checking the orientation, the orientation parameter determination unit 24a determines a coupling parameter between the heating unit 12a and the further placement item 82a. When checking the orientation, the orientation parameter determination unit 24a outputs the coupling parameter by way of the output unit 20a (cf. FIG. 18). When checking the orientation, the orientation parameter determination unit 24a outputs, via the output unit 20a, a per cent match of the coupling parameter with a desired value for the coupling parameter, in particular with a desired course for the coupling parameter.

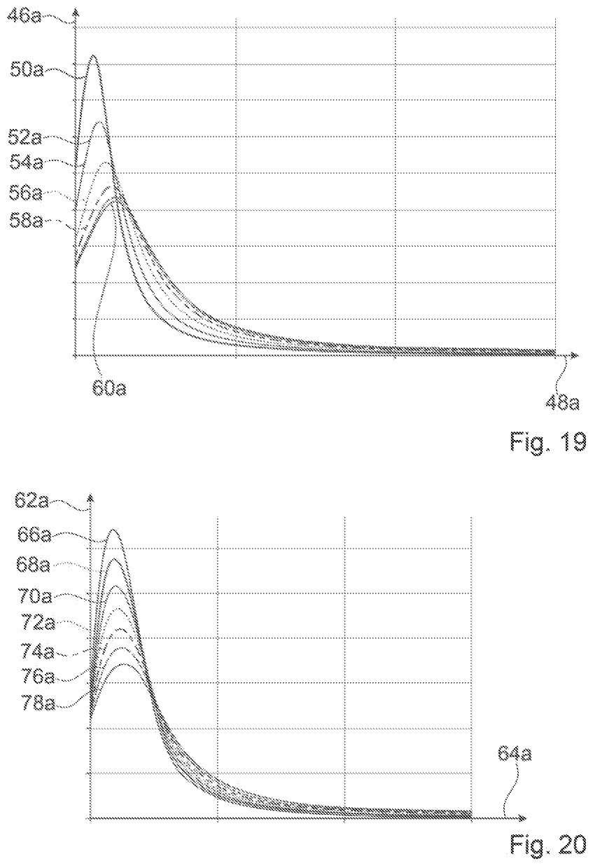

FIG. 19 shows a graph in which a plurality of courses of the coupling parameter is shown for the case of a horizontal distance between the heating unit 12a and the placement item 18a, in particular when viewed perpendicularly to a main extension plane of the heating unit 12a. The coupling parameter is plotted on an ordinate axis 46a. A frequency is plotted on an abscissa axis 48a. In the present exemplary embodiment, the coupling parameter has a maximum heat output that can be transferred by the heating unit 12a to the placement item 18a. Each of the courses of the coupling parameter represents a horizontal distance between the placement item 18a and the heating unit 12a.

A course 50a of the coupling parameter, shown by close-together dotted lines, represents a horizontal distance of the placement item 18a from the heating unit 12a of substantially 0 mm and thus corresponds to an overlap of the heating unit 12a and the placement item 18a when viewed perpendicularly to a main extension plane of the cooktop plate 14a. A course 52a of the coupling parameter, shown by a double dot-dash line, represents a horizontal distance of the placement item 18a from the heating unit 12a of substantially 20 mm. A course 54a of the coupling parameter, shown by wide-apart dotted lines, represents a horizontal distance of the placement item 18a from the heating unit 12a of substantially 40 mm. A course 56a of the coupling parameter, shown by wide-apart dashed lines, represents a horizontal distance of the placement item 18a from the heating unit 12a of substantially 60 mm. A course 58a of the coupling parameter, shown by close-together dashed lines, represents a horizontal distance of the placement item 18a from the heating unit 12a of substantially 80 mm. A course 60a of the coupling parameter, shown by dot-dash lines, represents a horizontal distance of the placement item 18a from the heating unit 12a of substantially 100 mm. It can be seen that, with increasing horizontal distance of the placement item 18a from the heating unit 12a, a maximum transferable heat output from the heating unit 12a to the placement item 18a decreases.

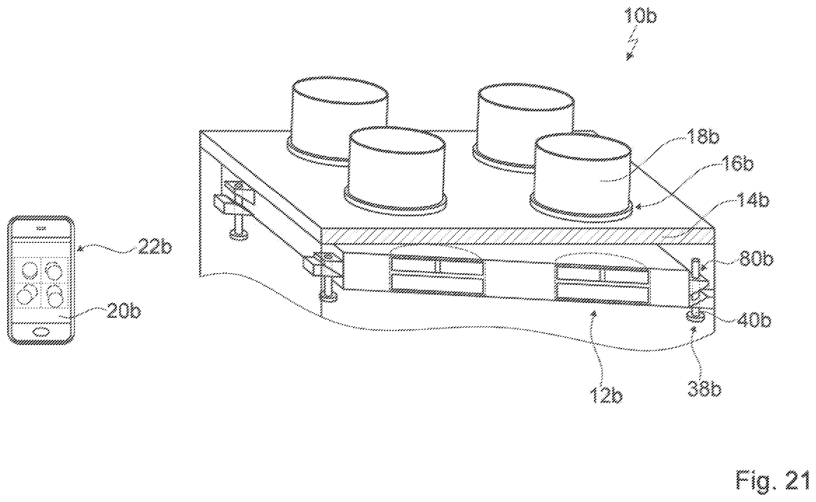

FIG. 20 shows a diagram in which a plurality of courses of the coupling parameter for the case of a vertical distance between the heating unit 12a and the desired placement position 16a is shown. The coupling parameter is plotted on an ordinate axis 62a. A frequency is plotted on an abscissa axis 64a. In the present exemplary embodiment, the coupling parameter has a maximum transferable heat output from the heating unit 12a to the placement item 18a positioned at the desired placement position 16a. Each of the courses of the coupling parameter represents a vertical distance of the heating unit 12a to a desired placement position 16a.

A course 66a of the coupling parameter, shown by solid lines, represents a vertical distance of the heating unit 12a from the desired placement position 16a of substantially 30 mm. A course 68a of the coupling parameter, shown by close-together dotted lines, represents a vertical distance of the heating unit 12a from the desired placement position 16a of substantially 32 mm. A course 70a of the coupling parameter, shown by double dot-dash lines, represents a vertical distance of the heating unit 12a from the desired placement position 16a of substantially 34 mm. A course 72a of the coupling parameter, shown by wide-apart dotted lines, represents a vertical distance of the heating unit 12a from the desired installing position 16a of substantially 36 mm. A course 74a of the coupling parameter, shown by wide-apart dashed lines, represents a vertical distance of the heating unit 12a from the desired placement position 16a of substantially 38 mm. A course 76a of the coupling parameter, shown by close-together dashed lines, represents a vertical distance of the heating unit 12a from the desired placement position 16a of substantially 40 mm. A course 78a of the coupling parameter, shown by dot-dash lines, represents a vertical distance of the heating unit 12a from the desired placement position 16a of substantially 42 mm. It can be seen that, with increasing vertical distance of the heating unit 12a from the desired placement position 16a, a maximum transferable heat output from the heating unit 12a to the placement item 18a decreases.

FIG. 21 to 30 show a further exemplary embodiment of the invention. The following descriptions are essentially restricted to the differences between the exemplary embodiments, reference being made to the description of the exemplary embodiment of FIG. 1 to 20 with respect to components, features and functions that remain the same. In order to distinguish the exemplary embodiments, the letter a in the reference numerals of the exemplary embodiment in FIG. 1 to 20 is replaced by the letter b in the reference numerals of the exemplary embodiment of FIG. 21 to 30. Reference may also be made in principle to the drawings and/or the description of the exemplary embodiment of FIG. 1 to 20 with respect to identically designated components, in particular in relation to components having the same reference numerals.

FIG. 21 to 30 show an implementation of a method for installing an alternative cooking system 10b, which has a plurality of heating units 12b, which are carried by a common heating unit carrier unit 80b. FIG. 21 to 30 show a transfer of the method described with reference to FIG. 1 to 20 on the basis of a single heating unit 12a to an alternative cooking system 10b with a larger number of heating units 12b. The method for installing a cooking system 10b, which has four heating units 12b, is described below by way of example.

FIG. 21 shows the cooking system 10b which has a plurality of heating units 12b. In the present exemplary embodiment, the cooking system 10b has four heating units 12b. The heating units 12b are carried in an installation position by a common heating unit carrier unit 80b. In an installation position, the heating units 12b are arranged below a cooktop plate 14b. The cooktop plate 14b is part of the cooking system 10b.

The cooktop plate 14b defines four desired placement positions 16b. The cooktop plate 14b defines one desired placement position 16b per heating unit 12b. A placement item 18b of the cooking system 10b is positioned in a close range of each of the desired placement positions 16b. In a method for installing the cooking system 10b, a position of a respective placement item 18b, which is to be heated by the heating unit 12b, is oriented relative to the corresponding heating unit 12b. In the course of the orientation of a position of the placement item 18b relative to the corresponding heating unit 12b, a placement orientation parameter is semi-automatically determined by means of an orientation parameter determination unit 24b of the cooking system 10b and taken into consideration in the orientation of the position of the placement item 18b relative to the corresponding heating unit 12b.

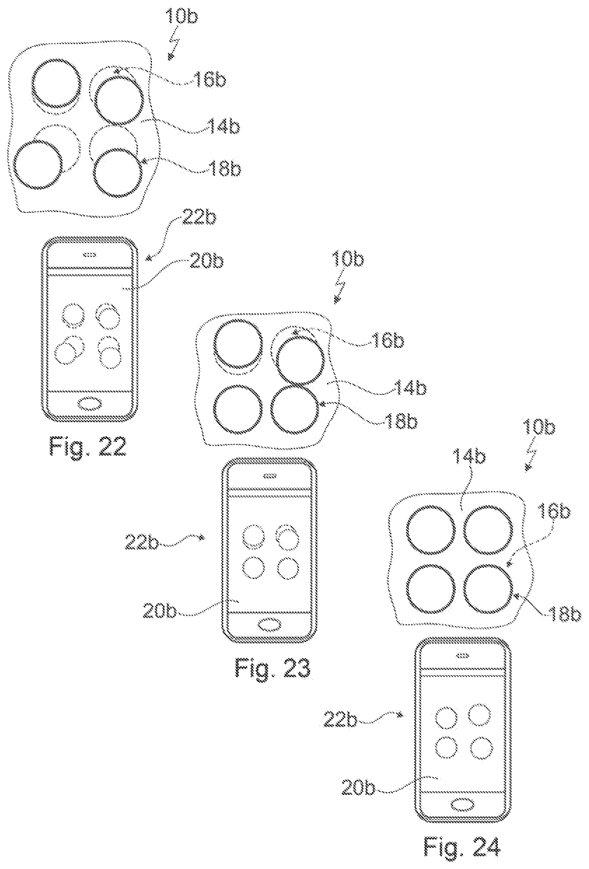

During the orientation of a position of the placement item 18b relative to the corresponding heating unit 12b, the positioning orientation parameter is given by an output unit 20b of the cooking system 10b, which is in particular part of a mobile device 22b of the cooking system 10b (cf. FIG. 22 to 24). During the orientation of a position of the placement item 18b relative to the corresponding heating unit 12b, the orientation parameter determination unit 24b outputs, via the output unit 20b, the position of the heating unit 12b and/or the desired placement position 16a and a current position of the placement item 18b, in particular relative to the heating unit 12b and/or to the desired placement position 16b.

Depending on the placement orientation parameter, a position of a first one of the placement items 18b is changed and a position of the corresponding desired placement position 16b and/or a position of the corresponding heating unit 12b is kept constant. The position of the first placement item 18b is changed until the position of the first placement item 18b and the position of the corresponding desired placement position 16b and/or the position of the corresponding heating unit 12b are arranged so as to overlap when viewed perpendicularly to a main extension plane of the cooktop plate 14b (cf. FIG. 22 to 24). Subsequently, in the same way, a current position of each of the placement items 18b is changed successively until the position of the respective placement item 18b and the position of the corresponding desired placement position 16b and/or the position of the corresponding heating unit 12b are arranged so as to overlap when viewed perpendicularly to a main extension plane of the cooktop plate 14b.

In the method for installing the cooking system 10b, a position of a respective one of the heating units 12b is oriented relative to the corresponding desired placement position 16b associated with the heating unit 12b. In the course of the orientation of a position of the respective heating unit 12b relative to the corresponding desired placement position 16b, an orientation parameter is determined semi-automatically by means of an orientation parameter determination unit 24b of the cooking system 10b, and is taken into consideration during the orientation of a position of the respective heating unit 12b relative to the corresponding desired placement position 16b.

During the orientation of a position of the respective heating unit 12b relative to the corresponding desired placement position 16b, a relative position of the respective heating unit 12b relative to the corresponding desired placement position 16b is determined, and, more precisely, in particular by the orientation parameter determination unit 24b. The orientation parameter has a relative position of the respective heating unit 12b relative to the corresponding desired placement position 16b (not shown). In an installation position, the relative position of the respective heating unit 12b relative to the corresponding desired placement position 16b has a vertical distance of the respective heating unit 12b relative to the corresponding desired placement position 16b (not shown).

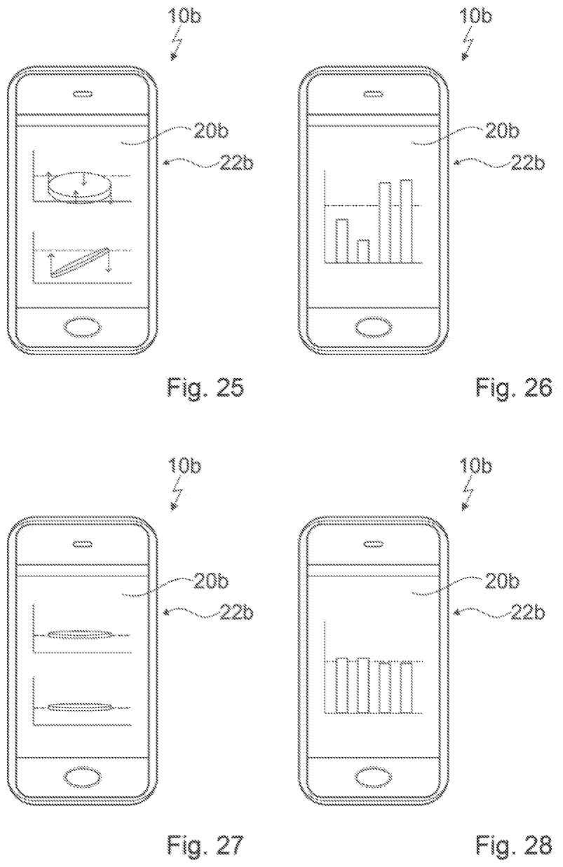

Following the relative position of the respective heating unit 12b relative to the corresponding desired placement position 16b, a relative angular orientation of the respective heating unit 12b relative to the corresponding desired placement position 16b is determined. The orientation parameter has a relative angular orientation of the respective heating unit 12b relative to the corresponding desired placement position 16b (cf. FIG. 25 to 28).

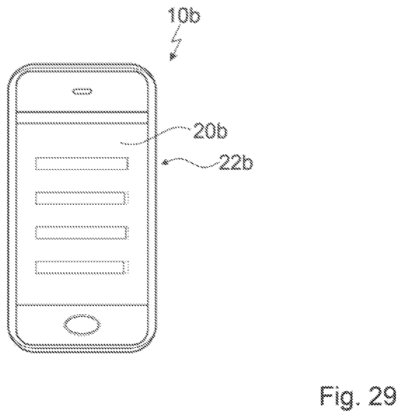

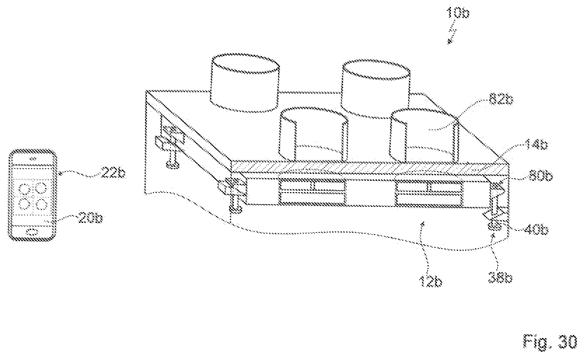

Following the orientation of a position of the respective heating unit 12b relative to the corresponding desired placement position 16b, the orientation is checked (cf. FIG. 29). The orientation parameter determination unit 24b outputs a result of checking of the orientation via the output unit 20b, and, more precisely, in particular for a respective heating unit 12b. When carrying out the check, a further placement item 82b different from the placement item 18b is used instead of the placement item 18b (cf. FIG. 30).

FIG. 30 shows the cooking system 10b of FIG. 21 in an oriented state of a position of the respective heating unit 12b relative to the corresponding desired placement position 16b following the method for installing the cooking system 10b. In contrast to the starting situation shown in FIG. 21, it can be seen that a main extension plane of the heating unit carrier unit 80b, following an orientation of a position of the respective heating unit 12b relative to the corresponding desired installing position 16b, is substantially oriented parallel to a main extension plane of the cooktop plate 14b. Accordingly, in the starting situation shown in FIG. 21, a main extension plane of the heating unit carrier unit 80b is oriented obliquely relative to a main extension plane of the cooktop plate 14b.

### REFERENCE NUMERALS

10 cooking system
12 heating unit
14 cooktop plate
16 desired placement position
18 placement item
20 output unit
22 mobile device
24 orientation parameter determination unit
26 cookware
28 support mechanism
30 operator interface
32 control unit
36 carrier unit
38 movement unit
40 movement element
42 coupling unit
44 coupling element
46 ordinate axis
48 abscissa axis
50 course
52 course
54 course
56 course
58 course
60 course
62 ordinate axis
64 abscissa axis
66 course
68 course
70 course
72 course
74 course
76 course
78 course
80 heating unit carrier unit
82 additional placement item

1-15. (canceled)

16. A method for installing a cooking system, comprising:
determining, at least semi-automatically, an orientation parameter in the course of an orientation of a position of a heating unit of the cooking system in relation to a desired placement position which is provided for a placement item and defined by a cooktop plate of the cooking system; and
taking into account the orientation parameter during the orientation of the position of the heating unit relative to the desired placement position.

17. The method of claim 16, wherein the orientation parameter includes a relative position of the heating unit relative to the desired placement position.

18. The method of claim 16, wherein the orientation parameter includes a relative angular orientation of the heating unit relative to the desired placement position.

19. The method of claim 16, further comprising outputting the orientation parameter via an output unit during the orientation of the position of the heating unit relative to the desired placement position.

20. The method of claim 19, wherein the output unit is at least partially part of a mobile device.

21. The method of claim 16, further comprising, during the orientation of the position of the heating unit relative to the desired position, changing a position of the heating unit and keeping constant a position of the desired placement position.

22. The method of claim 16, further comprising coupling the heating unit and the placement item to one another, when the orientation parameter is determined.

23. The method of claim 16, further comprising checking the orientation of the position of the heating unit relative to the desired position, once the position of the heating unit relative to the desired placement position has been oriented.

24. The method of claim 23, wherein the orientation is checked by using a further placement item which is different from the placement item.

25. A cooking system, comprising:
a placement item;
a cooktop plate which defines a desired placement position for the placement item; and
a heating unit having a position which is oriented relative to the desired placement position by determining, at least semi-automatically, an orientation parameter in the course of the orientation of the position of the heating unit and taking into account the orientation parameter during the orientation of the position of the heating unit relative to the desired placement position.

26. The cooking system of claim 25, further comprising an orientation parameter determination unit configured to determine the orientation parameter.

27. The cooking system of claim 26, wherein the orientation parameter determination unit is configured to include the heating unit.

28. The cooking system of claim 26, wherein the placement item is at least partially part of the orientation parameter determination unit.

29. The cooking system of claim 25, wherein the placement item includes an item of cookware.

30. The cooking system of claim 29, wherein the placement item is configured to include a support mechanism for positioning the item of cookware.
